(19) United States
(12) Patent Application Publication
(10) Pub. No.: US 2009/0025647 A1
(43) Pub. Date: Jan. 29, 2009

(54) Method of Grooming a Pet and Tool for Cutting Matted Fur

(76) Inventor: Danelle Jo Bashore, Pine, CO (US)

Correspondence Address: Leyendecker & Lemire, LLC, C/O PORTFOLIO IP, P.O. BOX 52050, MINNEAPOLIS, MN, 55402, US

(21) Appl. No.: 11/782,499

(22) Filed: Jul. 24, 2007

(51) Int. Cl. A01K 13/00; B26B 21/42

(52) U.S. Cl. 119/601; 119/611; 30/278; 30/317

(57) ABSTRACT

A tool that includes a razor blade edge disposed between a body of the tool and a protective tang is described along with a method of using the tool. Embodiments of the tool include a handle that extends downwardly from the tools body. A methodology of grooming a pet or a dog having matted fur is also described: the groomer places the protective tang into the pet's fur and against or close to the pet's body generally at a location above the matted section of the coat; and then the groomer pulls the tool downwardly or depending on the location of the matting, generally parallel with the natural orientation of the fur. The transverse strands of fur are pulled into the razor blade and cut. This process is repeated until the various strands of shed fur in the matted region are cut into relatively small pieces.

### FIELD OF THE INVENTION

The present invention relates generally to methods and products for grooming pets and other domesticated animals.

### BACKGROUND

Certain pets and certain breeds of dogs with long fur in particular have coats that are prone to matting. Unless such a pet is brushed regularly, dead shed fur becomes entangled with healthly fur thereby causing matting. The problem can be compounded when the pet's coat picks up or is in regular contact with dirt, water, mud and other contaminants. Dirt often acts as a binder hindering shed fur from simply sliding against and along healthy fur before harmlessly falling to the ground. Rather dirt, water, mud and other contaminants hold the shed fur in place which over time becomes intertwined and entangled with other pieces of shed fur and healthy fur to cause matting.

As an example, one breed of dog particularly susceptible to developing matted fur is a cocker spaniel. Cocker spaniels often have skirts of fur that hang down from their bodies and either come into contact with the ground or hang only an inch or so above the ground. Accordingly, the skirts are often dragged through mud, dirt and water eventually facilitating the formation of matting if the skirt is not regularly brushed.

Traditionally, it is very difficult for a groomer to remove matted shed fur and debris from healthy fur. Accordingly, groomers typically shave or cut the affected fur off of the animal. The dog (or other animal) then grows back his/her long fur coat over time. The next time the fur gets matted, the whole process is repeated. Owners generally prefer their pets in the pets' long fur style of coat prior to matting but are forced to endure the periodic grow out and matted coat phases there between. Depending on how much time the dog is permitted to play outside where it is exposed to dirt, water, mud and other elements, the amount of time the pet is not displaying his/her optimum coat is substantial.

### BRIEF DESCRIPTION OF THE DRAWINGS

FIG. 1 is a front view of a mat cutting tool for use in grooming a pet according to one embodiment of the present invention.

FIG. 2 is a side view of a mat cutting tool for use in grooming a pet according to one embodiment of the present invention.

FIG. 3 is a front view of a mat cutting tool for use in grooming a pet illustrating a portion as a cut away to show the configuration of a cutting blade according to one embodiment of the present invention.

FIG. 4 is a view of a matt cutting tool as it is orientated for us in cutting matted fur on a dog according to one embodiment of the present invention.

FIG. 5 is a rear view of a mat cutting tool for use in grooming a pet according to one embodiment of the present invention.

FIG. 6 is a flow chart describing a method of grooming a pet at least partially using the mat cutting tool according to one embodiment of the present invention.

### DETAILED DESCRIPTION

Embodiments of the present invention comprise a tool that includes a razor blade edge disposed between a body of the tool and a protective tang. Embodiments of the tool include a handle that extends downwardly from the tools body. The handle has a longitudinal axis that forms an acute angle, typically 45 degrees to less than 90 degrees, with the cutting edge of the razor blade. The handle permits a groomer to firmly grasp the tool while moving the tool downwardly through the matted fur thereby cutting the matted fur apart.

Embodiments of the present invention also include the methodology of grooming a pet or a dog. First, the groomer places the protective tang into the pet's fur and against or close to the pet's body generally at a location above the matted section of the coat. Next, the groomer, firmly grasping the handle, pulls the tool downwardly or depending on the location of the matting, generally parallel with the natural orientation of the fur. The transverse strands of fur (i.e. those orientated crosswise to the natural orientation or flow of the fur) are pulled into the razor blade and cut. This process is repeated until the various strands of shed fur in the matted region of the pet's coat are cut into relatively small pieces. The various shorter pieces of shed fur and any mud and dirt attached thereto along with a small portion of cut healthy fur can be combed out of the coat. The dog's coat can be then washed and groomed as necessary using traditional grooming techniques.

The result of using the matt cutting tool to cut and loosen the entangled shed strands of fur is that the majority of the healthy hair in the formally matted sections can be saved as opposed to being completely cut off using prior art methods of dealing with matted fur.

Embodiments of the matt cutting tool are comprised of an inexpensive plastic (such as polypropylene or polyethylene) that is typically injection molded around a suitably configured razor blade. The unit is typically disposable such that the entire unit, which costs only pennies to manufacture, can be discarded after each use or after several uses when the blade becomes dull. In at least one embodiment, the body of the tool is molded to resemble a face of a dog with the protective tang representing an ear.

### Terminology

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “one variation”, “a variations” and similar phrases mean that a particular feature, structure, or characteristic described in connection with the embodiment is included in at least an embodiment of the invention. The appearance of the phrase “in one embodiment” or “in an embodiment” in various places in the specification are all not necessarily meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

As applicable, the terms “about” or “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied.

### An Embodiment Comprising a Tool for Cutting Matted Fur

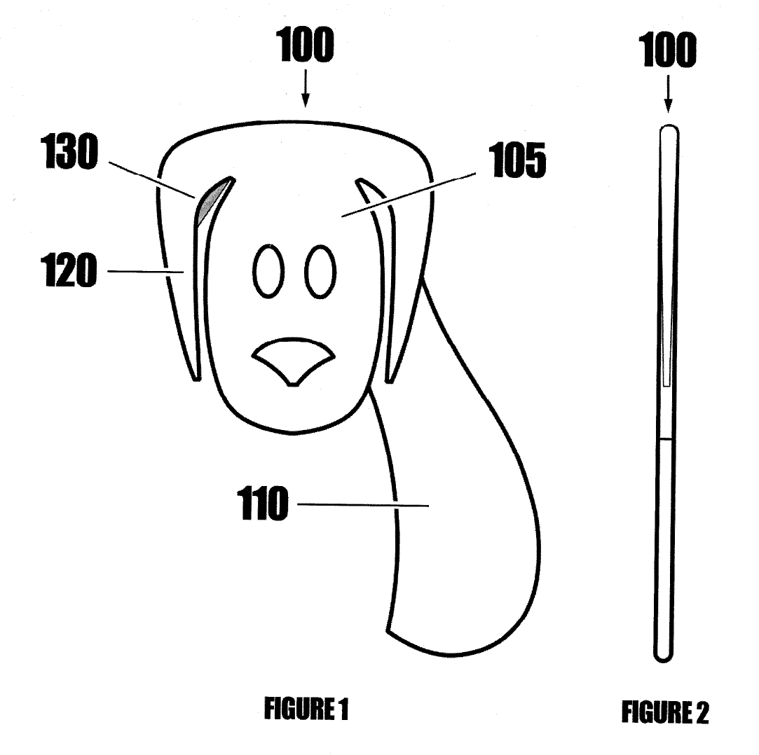

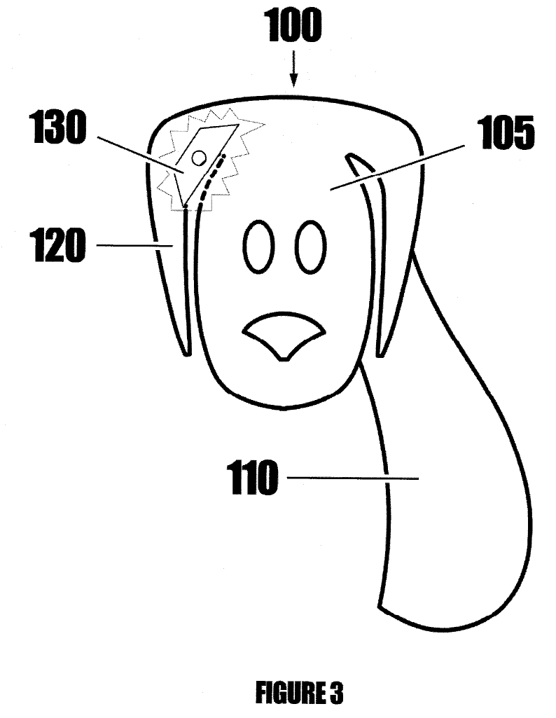

Referring to FIGS. 1, 2 & 4 an embodiment of a matted fur cutting tool 100 is illustrated. The tool is typically comprised of a plastic material molded around a razor blade such that only a portion of the blade is exposed. The entire tool is relatively thin and includes: (i) a relatively thin generally planar body 105; (ii) a razor blade 130 over which the body is partially molded at one edge of the body; (iii) a relatively thin protective tang 120 that is unitary with and protrudes from the body; and (iv) a handle portion 110 that is also unitary with the body and protrudes outwardly therefrom on a side generally diagonally opposite the razor blade.

The body 105 and its associated protrusions 120&110 are typically injection molded from a commodity grade thermoplastic, such as but not limited to polypropylene or polyethylene; however, engineering grade plastics, such as nylon may be used as well. In general, given the disposable nature of embodiments of the tool, the cost of the plastic material is a primary consideration in choosing a particular type of plastic. Other embodiments of tool can also be fabricated from a thermoset plastic material, such as through reaction injection molding.

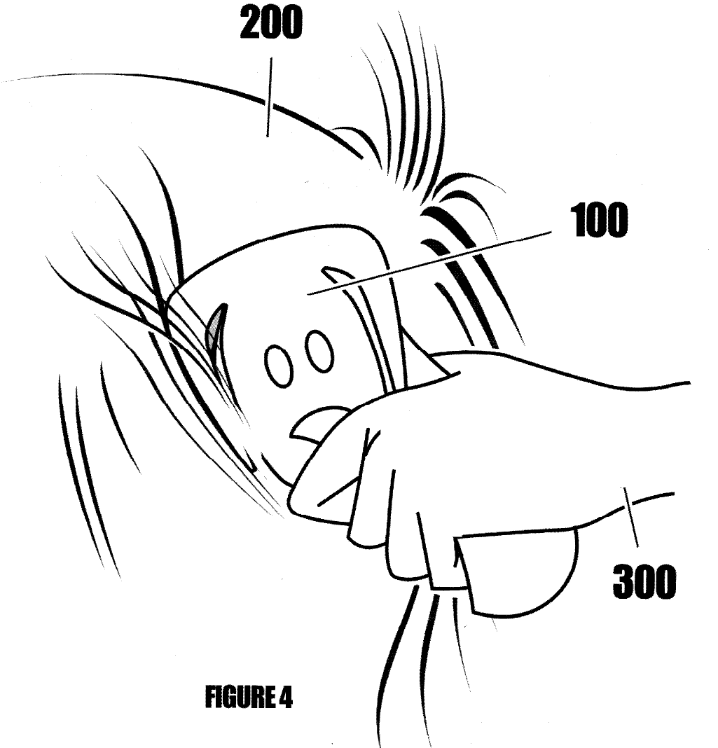

Before injection molding of the body and the protrusions, a razor blade 130 is placed in the injection molding die in an orientation wherein the surfaces of the blade and the subsequently formed planar surfaces of the body will be generally parallel with the significant portion of the blade being encapsulated between the body surfaces. As illustrated in FIG. 3, the blade is typically specifically designed for partial overmolding and may include features, such as one or more holes extending therethrough that receive molten plastic and firmly affix the blade in place once the plastic solidifies. The blade is typically made from a suitable steel and includes a sharpened or cutting edge that is at least partially exposed on the finished tool. In some variations, the steel may be of a stainless variety although given the disposable one time use intent of certain embodiments, the use of stainless steel over high carbon steel may not be warranted.

The razor blade 130 angles inwardly and upwardly such that it usually forms about a 30 degree to 85 degree angle with an adjacent side of the body 105. Operationally, this causes any fur that is caught between the tang 120 and the adjacent side of the body to be wedged against the blade between the blade edge and the edge of the adjacent side of the body thereby causing the blade to cut the fur as the tool is moved downwardly.

The injection molded variation of the matted fur cutting tool is typically relatively thin, about 0.10-0.20″ in thickness, as illustrated in FIG. 2. The actual thickness of any particular variation depends somewhat on the strength of the plastic material utilized as well as the stiffness or modulus of the plastic material. Less expensive plastic tend to be weaker and less stiff, and accordingly, require the tool to be made thicker than more expensive higher strength plastics.

The protective tang 120 first extends generally horizontally outwardly along a top edge of the body directly above an exposed portion of the razor blade 130. The overmolded portion of the blade is contained within this portion of the tang as well. The protective tang then turns about 90 degrees and extends downwardly spaced from but generally parallel to an adjacent side of the body. At its distal end, the tang tapers to provide a more pointed end that can be more easily inserted into a pet's matted coat.

The space between the adjacent edge of the body 105 and the generally parallel inside edge of the tang along with the razor blade at a top end thereof forms a slot into which the matted fur is drawn during use as a groomer pulls the tool generally downwardly. The distance between the spaced opposing generally parallel edges is typically between 0.050″ and 0.25″ with a distance of 0.10″ to 0.150″ being most typical.

The handle portion 110 extends downwardly from the body 105 from a location on the body across from and generally diagonally opposite the razor blade 130 location. A longitudinal axis of the handle portion forms an acute angle with the exposed cutting edge of the blade which is typically at least 30 degrees but equal to or less than 85 degrees. The handle is typically between 3-5″ in length and about 1-1.5″ in width. In the illustrated embodiment, the thickness of the handle is substantially similar to that of the body portion 105.

Variations and other embodiments are contemplated wherein the configuration of the tool varies somewhat from the illustrated version. For instance, some embodiments might utilize a thicker handle that essentially comprises a thin walled C-channel, such as is commonly found in disposable razors. In other embodiments, several parallel blades and associated protective tangs can be integrated into a single tool, such that a wider section of matter fur can be cut with each stroke. Embodiments are also contemplated wherein the tool is not disposable but rather uses replaceable razor blades. Ultimately, any embodiment or variation of the matt cutting tool will permit a groomer to pull a blade through a matted section of fur in a direction generally parallel with the direction of natural flow or orientation of the animal's fur in the matted section to cut the strands of entangled shed fur apart without cutting off a substantial portion of the healthy attached strands of fur in the section.

Method of Grooming a Domesticated Animal with Matted Fur.

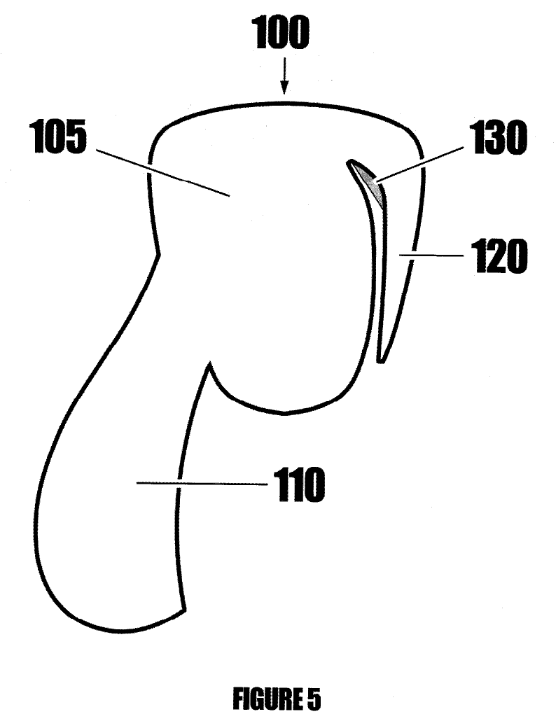

FIG. 4 illustrates how a matt cutting tool 100 is orientated relative to an animal 200 and held by a groomer 300 for use in cutting and removing the matted fur. Generally, the outer edge of the tang is orientated generally parallel to the surface of the animal's body that is directly below the portion/section of the matted fur that is to be cut. In use, the outer edge of the tang may even be rested against the animal's body surface as applicable. Furthermore, the outer edge of the tang is also generally orientated parallel relative to the natural longitudinal direction or flow of strands of healthy fur in the region to be cut.

When the tool is orientated in the foregoing position, the flat surfaces of the thin razor blade are orientated generally parallel with the natural flow, direction and/or longitudinal orientation of the pet's healthy attached strands of fur and generally orthogonal with the surface of one or both of the underlying adjacent portion of the animal's body and the surface of the coat of fur in the matted section. Stated another way, the length of the cutting edge of the razor blade neither normally spans strands of healthy fur nor does it face strands of healthy fur. In this orientation, the cutting edge of the razor blade, which is located at an edge of the blade, is exposed to strands (most typically shed strands) that span at least partially transversely across healthy strands. Accordingly, the transversely orientated strands are cut during tool use while many, if not most, of the healthy strands of fur remain uncut.

In contrast, a groomer using prior art techniques typically orientates the primary flat surfaces of the blades of shears or scissors such that they are generally orthogonal with (i) the natural flow, direction and/or longitudinal orientation of the pet's healthy attached strands of fur and (ii) the surface of one or both of the underlying adjacent portion of the animal's body and the surface of the coat of fur in the matted section. Restated, the cutting edge of the blade(s) face the healthy strands of fur. Accordingly during use, all or a significant portion of fur coming into forceful contact with the blades thereof is cutoff.

Also in contrast, a cutting edge of a razor blade using prior art techniques of shaving hair or fur faces the fur and extends orthogonally relative to the natural flow, direction and/or longitudinal orientation of the pet's healthy attached strands of fur, such that the length of the cutting edge faces and spans across numerous healthy strands of generally parallel fur. Explained another way, the cutting edge of the blade is parallel to one or both of the underlying adjacent portion of the animal's body and the surface of the coat of fur in the matted section. Additionally, the planar surface(s) of the blade are also orientated to be either acutely angled or orthogonal with the surface of one or both of the underlying adjacent portions of the animal's body and the surface of the coat of fur in the matted section.

As an example concerning the skirt fur of a cocker spaniel, the outer edge of the tang of a tool according to one or more embodiments is orientated vertically, and accordingly, generally parallel to the natural vertical flow of the strands of healthy skirt fur. In this example, there is no adjacent body portion directly below the skirt. As the tool is pulled generally downwardly, the strands of fur that are entangled and orientated at least partially horizontally between vertically orientated strands are cut.

It is to be appreciated that when a groomer inserts the tool into a section of matted fur he/she may tilt the tool appropriately such that the tapered distal end of the tang is orientated to pierce the matted fur; however, the tool is typically rotated or tilted back to an orientation wherein the outer edge of the tang is parallel to the natural direction of fur stand flow prior to pulling the tool downwardly to cut the matted fur. It is further appreciated that the relative orientations of the tool relative to the animal and its fur are not to be considered exacting. Rather, a relatively significant degree of variance in the tool's orientation is possible with the tool performing its intended function.

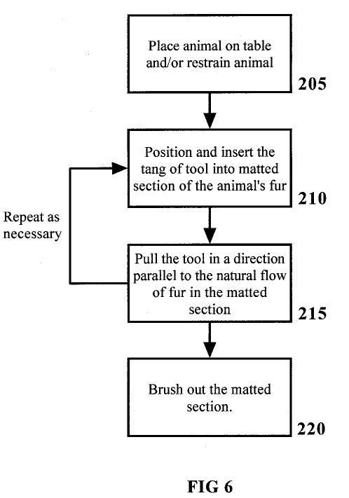

With reference to FIG. 6, a method of grooming a pet, such as a pet, is described below. First and optionally, the animal is placed on a grooming table and restrained as indicated in block 205. It is appreciated that pet owners may utilize the tool themselves as opposed to bring the animal to a grooming salon and as such, pet owners will typically perform the procedure while the dog is standing on a floor or other ground surface.

Next, the groomer, holding the tool by the handle, positions the matt cutting tool similarly as indicated in FIG. 4 and threads the tang into the matted portion of the animal's coat as indicated in block 210. As specified in block 215, the groomer pulls the tool downwardly or in a direction generally parallel to the natural direction of flow of the animal's fur in the matted portion, thereby cutting any strands of fur that are forced into the slot between the tang and the body and against the cutting edge of the razor blade 130.

The tool is then removed from the coat of matter fur and the groomer readjusts the position of the tool and reinserts it into the matted fur as indicated in block 215. As shown by line 220 the entire process is repeated typically until the tool moves freely through the coat without the need for the groomer to apply significant pulling force to the tool thereby indicating most of the entangled shed fur has been cut into smaller pieces and is also no longer entangled with the healthy fur.

Finally, the coat is brushed out as indicated in block 220 to remove the formally entangled shed fur from the healthy fur. The groomer can then finish grooming the animal in any suitable manner, such as but not limited to cutting and styling the animal's coat, and washing the animal.

### Other Embodiment and Other Variations

The various preferred embodiments and variations thereof illustrated in the accompanying figures and/or described above are merely exemplary and are not intended to limit the scope of the invention. It is to be appreciated that numerous variations to the invention have been contemplated as would be obvious to one of ordinary skill in the art with the benefit of this disclosure. All variations and embodiments of the invention that read upon the appended claims are intended and contemplated to be within the scope of thereof.

I claim:

1. A method of grooming an animal having an at least partially matted coat, the method comprising:
providing a tool for cutting matted hair, a tool comprising a generally planar body with a thickness of about 0.10-0.20″; a protective tang that is unitary with and protrudes from the body to form a slot between the tang and an adjacent edge of the body, the tang being coplanar with and having a similar thickness as the body, and a razor blade over which the body and the tang is at least partially molded with a cutting edge of the razor blade being exposed at a closed end of the slot, planar surfaces of razor blade being substantially parallel with the generally planar body.
placing a distal end of the tang into a matted section of the at least partially matted coat; and
cutting the matted fur apart by moving the tool in a direction generally parallel to the natural flow of the fur in the matted section.

2. The method of claim 1 further comprising repeating (i) said placing a distal end of the tang into a matted section of the at least partially matted coat, and (ii) said cutting the matted fur apart by moving the tool in a direction generally parallel to the natural flow of the fur in the matted section a plurality of times.

3. The method of claim 2, further comprising removing shed fur in the matted section by brushing the matted section after said repeating.

4. The method of claim 1, wherein the tool further includes a handle portion that is also unitary and coplanar with the body and protrudes outwardly therefrom on a side generally opposite the razor blade.

5. The method of claim 4, wherein said cutting the matted fur apart by moving the tool in a direction generally parallel to the natural flow of the fur in the matted section further comprising holding the handle portion in a hand and pulling the tool therefrom.

6. The method of claim 3 further comprising: washing the animal subsequently to said removing shed fur.

7. The method of claim 1, wherein the planar body is generally perpendicular to an adjacent underlying surface of the animal's body during said cutting.

8. The method of claim 1, wherein the planar body is generally perpendicular to an immediately surrounding surface of the matted section during said cutting.

9. The method of claim 1, wherein the animal comprises a dog.

10. The method of claim 2, further comprising disposing of the tool.

11. A method of removing the shed and entangled matted strands of fur from a matted section of an animal's coat by cutting the shed and entangled strands of fur without cutting a majority of the healthy attached fur in the matted section.

12. The method of claim 11 comprising:
placing a tool having a cutting edge into a section of matted fur on a animal; and
moving the cutting edge through the matted section in a direction parallel to the natural direction of flow of the healthy strands of fur while the cutting edge is generally orthogonal with one or both of (i) the underlying adjacent portion of the animal's body and (ii) the adjacent surface of the animal's coat whereby the matted fur is urged against the cutting edge.

13. The method of claim 12 further comprising repeating said placing and pulling.

14. The method of claim 12, wherein the tool comprises:
a razor blade having an overmolded polymeric body and associated tang, the overmolded body and tang being generally coplanar with the razor blade forming a slot between the body and the tang with an exposed cutting edge of the razor blade being located at a closed end of the slot.

15. The method of claim 14, wherein a width of the slot is 0.050″-0.250″.

16. A tool for cutting matted hair comprising:
a generally planar body with a thickness of about 0.10-0.20″;
a protective tang that is unitary with and protrudes from the body to form a slot between the tang and an adjacent edge of the body, the tang being coplanar with and having a similar thickness as the body;
a razor blade over which the body and the tang is at least partially molded with a cutting edge of the razor blade being exposed at a closed end of the slot, planar surfaces of razor blade being substantially parallel with the generally planar body; and
a handle portion that is unitary and coplanar with the body and protrudes outwardly therefrom on a side generally diagonally opposite the razor blade.

17. The tool of claim 16, wherein the body, the tang and the handle comprise a polymeric material.

18. The tool of claim 16, wherein a width of the slot is 0.050″-0.250″.

19. The tool of claim 16, wherein the body is molded in relief to resemble a face of a dog with the protective tang representing an ear.

20. The tool of claim 16 wherein an angle formed between a longitudinal axis of the handle portion and the cutting edge is greater than 30 degrees but equal to or less than 85 degrees.
